(19) United States
(12) Patent Application Publication
(10) Pub. No.: US 2021/0219326 A1
(43) Pub. Date: Jul. 15, 2021

(54) USER TERMINAL

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Xiaolin Hou, Beijing (CN)

(73) Assignee: NTT DOCOMO, INC., Tokyo (JP)

(21) Appl. No.: 17/054,373

(22) PCT Filed: May 11, 2018
(86) PCT No.: PCT/JP2018/018433

§ 371 Date: Nov. 10, 2020

(51) Int. Cl. H04W 72/12; H04L 1/00; H04W 72/04

(52) U.S. Cl. CPC H04W 72/1289; H04W 72/1263; H04W 72/0453; H04W 72/1257; H04W 72/0446; H04L 1/0068

(57) ABSTRACT

Provided is a user terminal that can appropriately control transmission of HARQ-ACK bits that correspond to DL assignments that are received after a UL grand. This user terminal comprising: a receiving section that receives, after receiving first downlink control information (DCI) used to schedule an uplink shared channel, second downlink control information (DCI) used to schedule a downlink shared channel; and a control section that controls, based on at least one of a number of transmission confirmation bits on the downlink shared channel and a time from reception of the second DCI until transmission of the uplink shared channel, transmission of transmission confirmation information using the uplink shared channel.

### TECHNICAL FIELD

The present disclosure relates to a user terminal in next-generation 1mobile communication systems.

### BACKGROUND ART

In the UMTS (Universal Mobile Telecommunications System) network, the specifications of Long Term Evolution (LTE) have been drafted for the purpose of further increasing high speed data rates, providing lower latency and so on (see Non-Patent Literature 1). For the purpose of further high capacity, advancement of LTE (LTE Rel. 8, Rel. 9), and so on, the specifications of LTE-A (LTE-Advanced, LTE Rel. 10, Rel. 11, Rel. 12, Rel. 13) have been drafted.

Successor systems of LTE (referred to as, for example, “FRA (Future Radio Access),” “5G (5th generation mobile communication system),” “5G+ (plus),” “NR (New Radio),” “NX (New radio access),” “FX (Future generation radio access),” “LTE Rel. 14,” “LTE Rel. 15” (or later versions), and so on) are also under study.

In an uplink (UL) in existing LTE systems (for example, LTE Rel. 8 to Rel. 13), DFT spread OFDM (DFT-s-OFDM (Discrete Fourier Transform-Spread-Orthogonal Frequency Division Multiplexing)) waveforms are supported. The DFT spread OFDM waveform is a single carrier waveform, and can thus prevent an increase in peak to average power ratio (PAPR).

In the existing LTE systems (for example, LTE Rel. 8 to Rel. 13), a user terminal (UE (User Equipment)) transmits uplink control information (UCI) by using a UL data channel (for example, a PUSCH (Physical Uplink Shared Channel) and/or a UL control channel (for example, a PUCCH (Physical Uplink Control Channel).

Transmission of the UCI is controlled on the basis of whether simultaneous PUSCH and PUCCH transmission is configured or not and whether the PUSCH is scheduled for a TTI during which the UCI is transmitted or not.

In a case where a transmission timing for uplink data (for example, UL-SCH) overlaps a transmission timing for uplink control information (UCI), a UE uses the uplink shared channel (PUSCH) to transmit the uplink data and the UCI. Utilizing the PUSCH to transmit the UCI is referred as UCI on PUSCH.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, LTE Rel. 16 or later versions, 5G, NR, and so on, hereinafter also simply referred to as NR), studies have been conducted regarding the use of an uplink shared channel (for example, the PUSCH (Physical Uplink Shared Channel) scheduled by a UL grant to transmit transmission conformation bits (HARQ-ACK bits) for a downlink shared channel (for example, a PDSCH (Physical Downlink Shared Channel) scheduled by a DL assignment received after the UL grant. Here, the UL grant is downlink control information (DCI) used to schedule the PUSCH (first DCI). The DL assignment is DCI used to schedule the PDSCH (second DCI).

However, the existing LTE systems (for example, LTE Rel. 8 to Rel. 13) are not assumed to transmit, by using the PUSCH scheduled by the UL grant, the HARQ-ACK bits corresponding to the DL assignment received after the UL grant. This is because, in the existing LTE systems, the timing for the HARQ-ACK bits corresponding to the DL assignment is fixed and is not assumed to be controlled.

Accordingly, if transmission of the UCI using the PUSCH in the existing LTE system is applied to the future radio communication system, the transmission of the HARQ-ACK bits corresponding to the DL assignment received after the UL grant may fail to be appropriately controlled.

Thus, an object of the present disclosure is to provide a user terminal that can appropriately control transmission of the HARQ-ACK bits corresponding to the DL assignment received after the UL grant.

### Solution to Problem

A user terminal according to an aspect of the present disclosure includes a receiving section that receives, after receiving first downlink control information (DCI) used to schedule an uplink shared channel, second downlink control information (DCI) used to schedule a downlink shared channel, and a control section that controls, based on at least one of a number of transmission confirmation bits on the downlink shared channel and a time from reception of the second DCI until transmission of the uplink shared channel, transmission of the transmission confirmation information using the uplink shared channel.

### Advantageous Effects of Invention

According to an aspect of the present disclosure, transmission of HARQ-ACK bits corresponding to a DL assignment received after a UL grant can be appropriately controlled.

### BRIEF DESCRIPTION OF DRAWINGS

FIG. 1 is a diagram to show an example of control of UCI on PUSCH in existing LTE;

FIG. 2 is a diagram to show an example of control of UCI on PUSCH assumed in NR;

FIG. 3 is a diagram to show an example of transmission control of HARQ-ACK according to Aspect 3.1;

FIG. 4 is a diagram to show an example of transmission control of HARQ-ACK according to Aspect 3.2;

FIG. 5 is a diagram to show an example of transmission control of HARQ-ACK according to Aspect 3.3;

FIG. 6 is a diagram to show an example of a schematic structure of a radio communication system according to one embodiment;

FIG. 7 is a diagram to show an example of an overall structure of a radio base station according to one embodiment;

FIG. 8 is a diagram to show an example of a functional structure of the radio base station according to one embodiment;

FIG. 9 is a diagram to show an example of an overall structure of a user terminal according to one embodiment;

FIG. 10 is a diagram to show an example of a functional structure of the user terminal according to one embodiment; and

FIG. 11 is a diagram to show an example of a hardware structure of the radio base station and the user terminal according to one embodiment.

### DESCRIPTION OF EMBODIMENTS

In NR, studies have been conducted regarding the use, as a scheduling unit for a data channel (including a DL data channel and/or a UL data channel, also simply referred to as data or the like), of a time unit for which a time length can be varied (for example, at least one of a slot, a mini-slot, and a certain number of symbols).

Here, the slot is a time unit based on a numerology applied to transmission and/or reception by the UE (for example, a subcarrier spacing and/or a symbol length). The number of symbols per slot may be set according to the subcarrier spacing. For example, in a case where the subcarrier spacing is 15 kHz or 30 kHz, the number of symbols per slot may be 7 or 14 symbols. On the other hand, in a case where the subcarrier spacing is 60 kHz or more, the number of symbols per slot may be 14 symbols.

The subcarrier spacing and the symbol length are in an inverse relationship. Thus, with the same number of symbols per slot, the slot length decreases with increasing (wider) subcarrier spacing and increases with decreasing (narrower) subcarrier spacing.

The mini-slot is a time unit shorter than the slot. The mini-slot may be constituted of symbols the number of which (for example, one to (slot length−1) symbols, for example, two or three symbols) is smaller than the number of symbols of slots. The same numerology as that for the slots (for example, the subcarrier spacing and/or the symbol length) may be applied to the mini-slots in the slot or a numerology different from the numerology for the slots (for example, a subcarrier spacing larger than that for the slots and/or a symbol length smaller than that for the slots) may be applied to the mini-slots in the slot.

For the future radio communication systems, with time units different from the time units for the existing LTE systems introduced, a plurality of time units are expected to be applied to scheduling of data and the like to control transmission and/or reception (or allocation or the like) of signals and/or channels. In a case where different time units are used to schedule data and the like, a plurality of transmission timings/transmission periods and the like for data are expected to take place. For example, a UE supporting a plurality of time units performs transmission and/or reception of data scheduled in the different time units.

As an example, a scheduling (slot-based scheduling) with a first time unit (for example, the slot unit) and a scheduling (non-slot-based scheduling) with a second time unit shorter than the first time unit (for example, a non-slot unit) may be applied. The non-slot unit may be the mini-slot unit or the symbol unit. Note that the slot is constituted of, for example, seven or 14 symbols and that the mini-slot can be constituted of one to (slot length−1) symbols.

In this case, a transmission timing/transmission period for the data in a time direction varies according to the scheduling unit for the data. For example, in a case where the scheduling is in the slot unit, one data may be allocated to one slot. On the other hand, in a case where the scheduling is in the non-slot unit (mini-slot unit or symbol unit), data is selectively allocated to a partial region of one slot. Thus, in a case where the scheduling is in the non-slot unit, a plurality of data can be allocated to one slot.

For the future radio communication systems (for example, LTE Rel. 16 or later versions, 5G, NR, and so on), it is expected that the transmission timing/transmission period for the data or the like is made changeable for each scheduling (each transmission) to flexibly control the scheduling of the data or the like. For example, in the non-slot unit scheduling, for the data (for example, the PDSCH and/or PUSCH), an allocation position may be started at one of the symbols for each scheduling, and the data may be allocated over a certain number of symbols.

Like the data for which the transmission timing/transmission period is variably controlled (for example, the PDSCH and/or PUSCH), it is expected that UCI for the data (for example, A/N) is configured such that the transmission timing/transmission period is changeable for each transmission. For example, a base station utilizes downlink control information and/or higher layer signaling or the like to specify, for the UE, the transmission timing/transmission period for the UCI. In this case, an A/N feedback timing is flexibly set to take place during a period after downlink control information used to report the transmission timing/transmission period for the A/N and/or the corresponding PDSCH.

As described above, for the future radio communication systems, it is expected that one or both of the transmission timing/transmission period for the A/N for DL data and the transmission timing/transmission period for the PUSCH are flexibly configured. On the other hand, UL transmission requires a low PAPR (Peak-to-Average Power Ratio) and/or low inter-modulation distortion (IMD).

For achievement of a low PAPR and/or low IMD for UL transmission, a method is available in which, in a case where UCI transmission and UL data (UL-SCH) transmission take place at the same timing, the UCI and the UL data are multiplexed on the PUSCH for transmission (the method is also referred to as UCI piggyback on PUSCH, UCI on PUSCH).

In the existing LTE systems, in a case where the UL data and the UCI (for example, A/N) are transmitted by utilizing the PUSCH, puncture processing is executed on the UL data, and the UCI is multiplexed on the resource subjected to the puncture processing. This is because, in the existing LTE systems, the capacity (or rate) of the UCI multiplexed on the PUSCH is not very high and/or because, even in a case where the UE makes a mistake in detecting the DL signal, complicated reception processing in the base station is suppressed.

Puncture processing executed on data refers to executing coding on the assumption that resources allocated for the data are available (or the amount of resources unavailable is not taken into account), but avoiding mapping coding symbols to actually unavailable resources (for example, UCI resources) (the resources are set aside). The receiving side avoids using, for decoding, the coding symbols for the punctured resources, allowing suppression of characteristic degradation due to the puncture.

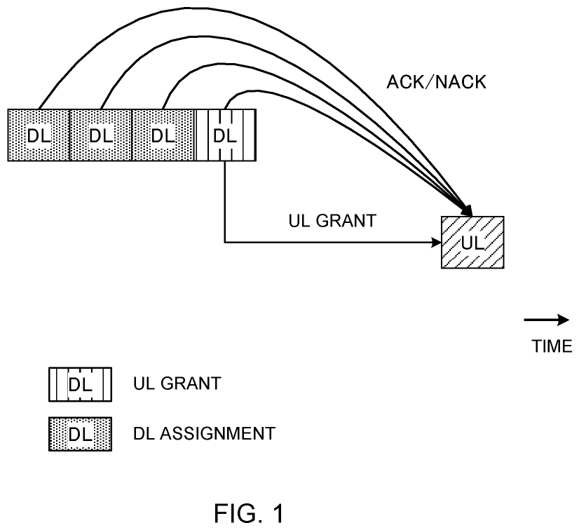

FIG. 1 is a diagram to show an example of control of UCI on PUSCH in existing LTE. In the present example, portions labeled “DL” or “UL” indicate certain resources (for example, time/frequency resources), and the periods of the portions correspond to optional time units (for example, one or more slots, mini-slots, symbols, subframes, or the like). This also applies to the following examples.

In the case of FIG. 1, the UE transmits ACK/NACK corresponding to the four illustrated DL resources by using UL resources indicated by a certain UL grant. In the existing LTE, the UL grant is constantly provided at the last timing in a HARQ-ACK bundling window or a later timing.

Here, the HARQ-ACK bundling window may also be referred as a HARQ-ACK feedback window, simply as a bundling window, or the like, and corresponds to a period when A/N feedback is performed at the same timing. For example, the UE determines that a given period from a DL resource indicated by a certain DL assignment is a bundling window, and generates A/N bits corresponding to the window to control the feedback.

Like the existing LTE systems, the future radio communication systems are also expected to perform UCI on PUSCH.

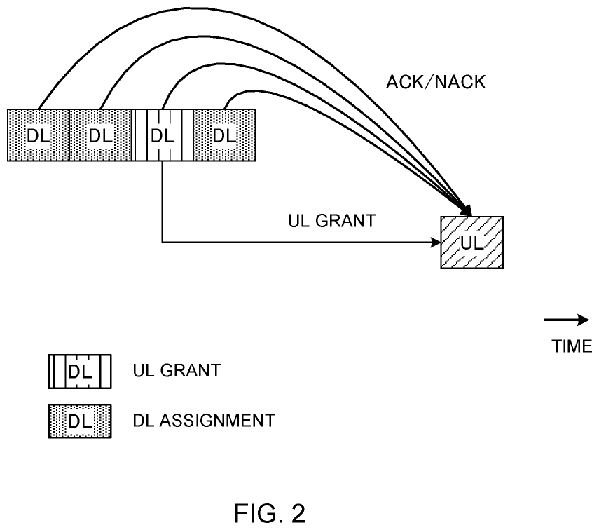

FIG. 2 is a diagram to show an example of control of UCI on PUSCH assumed in NR. FIG. 2 is similar to FIG. 1 but differs from FIG. 1 in that, after the UL grant is provided, the DL data included in the bundling window is still scheduled. Accordingly, for NR, studies have been conducted regarding provision of the UL grant for transmission of HARQ-ACK before the last timing in the bundling window.

As shown in FIG. 2, for the future radio communication systems, it is expected that transmission conformation bits (HARQ-ACK bits) for a downlink shared channel (for example, the PDSCH (Physical Downlink Shared Channel) scheduled by the DL assignment received after the UL grant are transmitted by using an uplink shared channel (for example, the PUSCH (Physical Uplink Shared Channel) scheduled by the UL grant.

However, as shown in FIG. 1, the existing LTE systems (for example, LTE Rel. 8 to Rel. 13) are not assumed to transmit, by using the PUSCH scheduled by the UL grant, the HARQ-ACK bits corresponding to the DL assignment received after the UL grant.

Accordingly, when transmission of the UCI using the PUSCH in the existing LTE system is applied to the future radio communication system, the transmission of the HARQ-ACK bits corresponding to the DL assignment received after the UL grant may fail to be appropriately controlled. Thus, by studying methods for appropriately controlling transmission of the HARQ-ACK bits corresponding to the DL assignment received after the UL grant, the inventors have arrived at the present invention.

Embodiments of the present disclosure will be described in detail. Note that the UCI may include at least one of a scheduling request (SR), transmission confirmation information (also referred to as HARQ-ACK (Hybrid Automatic Repeat reQuest-Acknowledge, ACK or NACK (Negative ACK), A/N, or the like) for a DL data channel (for example, the PDSCH (Physical Downlink Shared Channel)), channel state information (CSI), beam index information (BI (Beam Index)), and a buffer status report (BSR). Note that the HARQ-ACK may be interpreted as UCI and may also be interpreted as other types of UCI such as SR and CSI in the following.

Rate-matching data refers to controlling the number of bits resulting from coding (coded bits) with actually available radio resources taken into account. In a case where the number of coded bits is smaller than the number of bits that can be mapped to the actually available radio resources, at least some of the coded bits may be iterated. In a case where the number of coded bits is larger than the number of bits that can be mapped, some of the coded bits may be deleted.

Rate matching executed on the UL data causes the actually available resources to be taken into account, allowing coding to be achieved with a high coding rate (with high performance) compared to the puncture processing. Accordingly, for example, by employing the rate matching processing instead of the puncture processing in a case where the UCI has a large payload size, the UL signal can be generated with higher quality, allowing communication quality to be improved.

### (Aspect 1)

In Aspect 1, for the HARQ-ACK for the DL assignment after the UL grant, the number of bits to be fed back may be limited. The number of bits may be limited to X bits (for example, X=2).

The user terminal may transmit the HARQ-ACK with the X bits corresponding to the DL assignment after the UL grant, with the UL data of the PUSCH punctured. In a case where the number of DL assignments received after the UL grant is larger than X, the user terminal may trigger an error event.

### (Aspect 2)

Aspect 2 differs from Aspect 1 in that, for the HARQ-ACK for the DL assignment after the UL grant, the number of bits to be fed back is not limited.

### (Aspect 2.1)

The user terminal may bundle (for example, space bundling) at least one of the HARQ-ACKs for the DL assignments after the UL grant to generate an HARQ-ACK with X bits. The user terminal may transmit the HARQ-ACK with the X bits, with the UL data of the PUSCH scheduled by the UL grant punctured. Accordingly, even in a case where the number of bits of the HARQ-ACK for the DL assignment after the UL grant is larger than X bits, the HARQ-ACK can be fed back.

(Aspect 2.2) In a case where the number of bits of the HARQ-ACK for the DL assignment after the UL grant is larger than (or equal to or larger than) X bits, the user terminal may drop the PUSCH scheduled by the UL grant and transmit the HARQ-ACK with more than the X bits by using the PUCCH.

On the other hand, in a case where the number of bits of the HARQ-ACK for the DL assignment after the UL grant is equal to or smaller than (or smaller than) X bits, the user terminal may transmit the HARQ-ACK by using the PUSCH scheduled by the UL grant.

(Aspect 3)

The control of feedback of the HARQ-ACK for the PDSCH scheduled by the DL assignment received after the UL grant will further be described.

### (Aspect 3.1)

The user terminal may transmit the HARQ-ACK with X bits (for example, X=2) for the DL assignment after the UL grant, by using the PUSCH scheduled by the UL grant. In this case, the user terminal may transmit the HARQ-ACK with the X bits, with UL data of the PUSCH punctured.

In a case where the actual number of bits of the HARQ-ACK for the DL assignment after the UL grant is larger than the X bits, the user terminal may suspend (may drop) the transmission of the HARQ-ACK bits, which are more than the X bits.

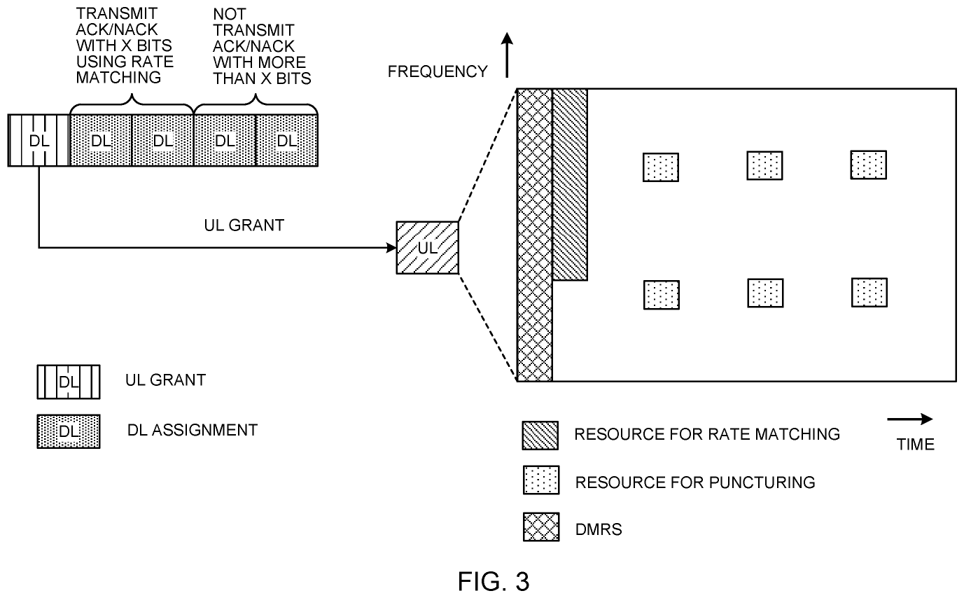

FIG. 3 is a diagram to show an example of transmission control of HARQ-ACK according to Aspect 3.1. FIG. 3 shows an example in which the user terminal detects a certain number of (here, four) DL assignments after the UL grant.

In FIG. 3, the user terminal may transmit the HARQ-ACK with X bits (for example, X=2) for the DL assignment after the UL grant, by using the PUSCH scheduled by the UL grant. As shown in FIG. 3, the user terminal may transmit the HARQ-ACK with the X bits, with the UL data of the PUSCH punctured. On the other hand, the user terminal need not transmit the HARQ-ACK with more than X bits.

As shown in FIG. 3, within the frequency resources allocated to the PUSCH, resources for rate matching and resources for puncturing may be separately provided. In FIG. 3, the user terminal may map the HARQ-ACK with X bits to the resources for rate matching and transmit the HARQ-ACK.

In Aspect 3.1, based on the number of bits of the HARQ-ACK for the DL assignment after the UL grant, the transmission of the HARQ-ACK is controlled. Thus, the user terminal can easily control the transmission of the HARQ-ACK.

### (Aspect 3.2)

The user terminal may control the feedback of the HARQ-ACK corresponding to the DL assignment after the UL grant based on processing capability of a user terminal (UE processing capability). Here, the UE processing capability may be, for example, time from reception of the UL grant until transmission of the PUSCH corresponding to the UL grant (processing time).

Specifically, based on a time difference between a timing for the DL assignment after the UL grant (reception timing, detection timing) and the transmission timing for the PUSCH scheduled by the UL grant, the feedback of the HARQ-ACK corresponding to the DL assignment may be controlled.

For example, in a case where the time difference is equal to or larger than a certain threshold N2 (or larger than the certain threshold N2), the user terminal may transmit the HARQ-ACK corresponding to the DL assignment after the UL grant, by using the PUSCH scheduled by the UL grant. In this case, the user terminal may rate-match the UL data of the PUSCH and transmit the HARQ-ACK with the X bits.

On the other hand, in a case where the time difference is smaller than the certain threshold N2 (equal to or smaller than the certain threshold N2), the user terminal may suspend (may drop) the transmission of the HARQ-ACK corresponding to the DL assignment after the UL grant.

Here, the certain threshold N2 may be configured or controlled by at least one of higher layer signaling and physical layer signaling. For example, the certain threshold N2 may be a value configured (controlled) based on the processing capability of the user terminal. The user terminal may receive, from the radio base station, information indicating the certain threshold N2. Note that the certain threshold may be a fixed value determined in advance in specifications.

For example, the higher layer signaling may be at least one of RRC (Radio Resource Control) signaling, broadcast information (master information blocks (MIBs), system information blocks (SIBs), and so on), or MAC (Medium Access Control) signaling. The physical layer signaling may be, for example, downlink control information (DCI).

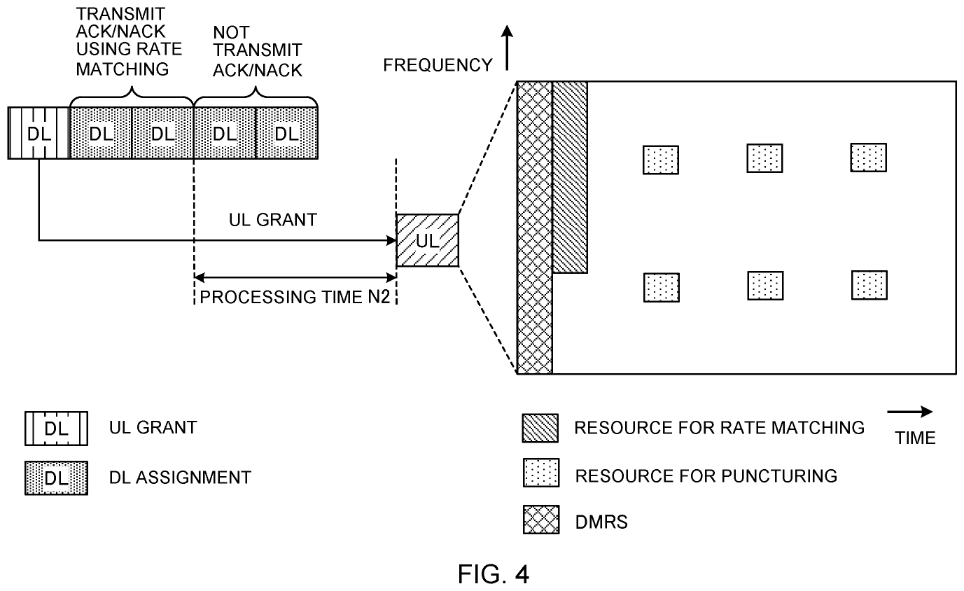

FIG. 4 is a diagram to show an example of transmission control of HARQ-ACK according to Aspect 3.2. FIG. 4 shows an example in which the user terminal detects a certain number of (here, four) DL assignments after the UL grant.

In FIG. 4, in a case where the time difference between the timing for the DL assignment after the UL grant and the timing for the PUSCH scheduled by the UL grant is larger than the processing time N2 (or equal to or larger than the processing time N2), the user terminal may transmit the HARQ-ACK corresponding to the DL assignment. On the other hand, in a case where the time difference is equal to or smaller than the processing time N2 (smaller than the certain processing time N2), the user terminal may suspend the transmission of the HARQ-ACK corresponding to the DL assignment.

As shown in FIG. 4, in a case where, within the frequency resources allocated to the PUSCH, the resources for rate matching and the resources for puncturing are separately provided, the user terminal may map the HARQ-ACK for the DL assignment with the time difference larger than the processing time N2 (or equal to or larger than the processing time N2) to the resources for rate matching for transmission.

In Aspect 3.2, based on the time difference between the timing for the DL assignment after the UL grant and the timing for the PUSCH scheduled by the UL grant, the transmission of the HARQ-ACK corresponding to the DL assignment can be appropriately controlled.

### (Aspect 3.3)

In Aspect 3.3, as is the case with Aspect 3.2, the user terminal may control the feedback of the HARQ-ACK corresponding to the DL assignment after the UL grant, based on the UE processing capability.

Aspect 3.3 differs from Aspect 3.2 in that in a case where the time difference between the timing for the DL assignment after the UL grant and the transmission timing for the PUSCH scheduled by the UL grant is smaller than the certain threshold N2 (or equal to or smaller than the certain threshold N2), the HARQ-ACK corresponding to the DL assignment after the UL grant is transmitted by using the PUSCH scheduled by the UL grant.

In Aspect 3.3, in a case where the time difference is smaller than the certain threshold N2 (equal to or smaller than the certain threshold N2), the user terminal may transmit the HARQ-ACK corresponding to the DL assignment after the UL grant, with the UL data of the PUSCH punctured. In a case where the number of bits of the HARQ-ACK is larger than the X bits, the user terminal may bundle (for example, space bundling) at least one bit of the HARQ-ACK, and transmit the HARQ-ACK with the X bits, with the UL data of the PUSCH punctured.

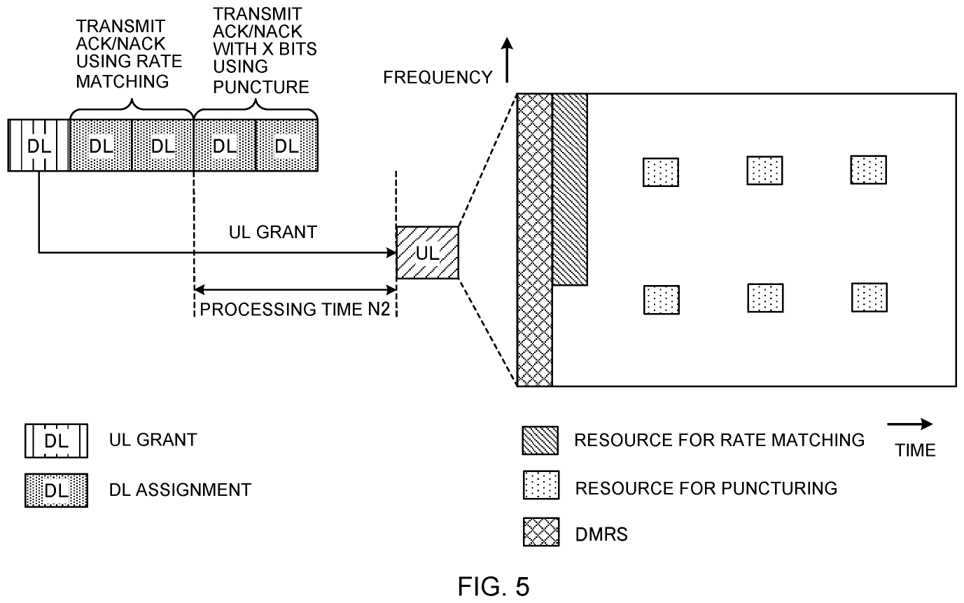

FIG. 5 is a diagram to show an example of transmission control of HARQ-ACK according to Aspect 3.3. FIG. 5 shows an example in which the user terminal detects a certain number of (here, four) DL assignments after the UL grant. In FIG. 5, differences from FIG. 4 will be mainly described.

In FIG. 5, even in a case where the time difference between the timing for the DL assignment after the UL grant and the timing for the PUSCH scheduled by the UL grant is equal to or smaller than the processing time N2 (or smaller than the processing time N2), the user terminal may transmit the HARQ-ACK corresponding to the DL assignment.

As shown in FIG. 5, in a case where, within the frequency resources allocated to the PUSCH, the resources for rate matching and the resources for puncturing are separately provided, the user terminal may map the HARQ-ACK for the DL assignment with the time difference equal to or smaller than the processing time N2 (or smaller than the processing time N2) to the resources for puncturing for transmission.

Note that, in a case where the number of bits of the HARQ-ACK for the DL assignment with the time difference equal to or smaller than the processing time N2 (or smaller than the processing time N2) is larger than the X bits, the user terminal may bundle at least one of the HARQ-ACKs to generate an HARQ-ACK with the X bits and map the HARQ-ACK with X bits to the resources for puncturing.

In Aspect 3.3, the HARQ-ACK for the DL assignment for which the time difference between the timing for the DL assignment after the UL grant and the timing for the PUSCH scheduled by the UL grant is equal to or smaller than the certain threshold N2 (or smaller than the processing time N2) can be fed back.

### (Radio Communication System)

Hereinafter, a structure of a radio communication system according to one embodiment will be described. In this radio communication system, a combination of at least one of the plurality of aspects described above is used for communication.

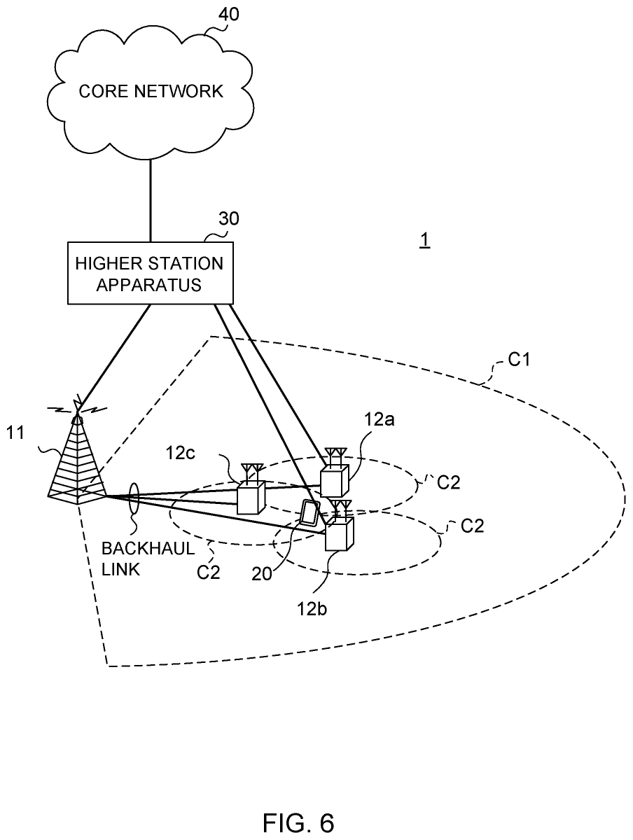

FIG. 6 is a diagram to show an example of a schematic structure of the radio communication system according to one embodiment. A radio communication system 1 can adopt carrier aggregation (CA) and/or dual connectivity (DC) to group a plurality of fundamental frequency blocks (component carriers) into one, where the system bandwidth in an LTE system (for example, 20 MHz) constitutes one unit.

Note that the radio communication system 1 may be referred to as “LTE (Long Term Evolution),” “LTE-A (LTE-Advanced),” “LTE-B (LTE-Beyond),” “SUPER 3G,” “IMT-Advanced,” “4G (4th generation mobile communication system),” “5G (5th generation mobile communication system),” “NR (New Radio),” “FRA (Future Radio Access),” “New-RAT (Radio Access Technology),” and so on, or may be referred to as a system implementing these.

The radio communication system 1 includes a radio base station 11 that forms a macro cell C1 of a relatively wide coverage, and radio base stations 12 (12a to 12c) that form small cells C2, which are placed within the macro cell C1 and which are narrower than the macro cell C1. Also, user terminals 20 are placed in the macro cell C1 and in each small cell C2. The arrangement, the number, and the like of each cell and user terminal 20 are by no means limited to the aspect shown in the diagram.

The user terminals 20 can connect with both the radio base station 11 and the radio base stations 12. It is assumed that the user terminals 20 use the macro cell C1 and the small cells C2 at the same time by means of CA or DC. The user terminals 20 may employ CA or DC by using a plurality of cells (CCs) (for example, five or less CCs, six or more CCs).

Between the user terminals 20 and the radio base station 11, communication can be carried out by using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz, and so on) and a wide bandwidth may be used, or the same carrier as that used between the user terminals 20 and the radio base station 11 may be used. Note that the structure of the frequency band for use in each radio base station is by no means limited to these.

The user terminals 20 can perform communication by using time division duplex (TDD) and/or frequency division duplex (FDD) in each cell. Furthermore, in each cell (carrier), a single numerology may be employed, or a plurality of different numerologies may be employed.

Numerologies may be communication parameters applied to transmission and/or reception of a certain signal and/or channel, and for example, may indicate at least one of a subcarrier spacing, a bandwidth, a symbol length, a cyclic prefix length, a subframe length, a TTI length, the number of symbols per TTI, a radio frame structure, filtering processing, windowing processing, and so on.

A wired connection (for example, means in compliance with the CPRI (Common Public Radio Interface) such as an optical fiber, an X2 interface and so on) or a wireless connection may be established between the radio base station 11 and the radio base stations 12 (or between two radio base stations 12).

The radio base station 11 and the radio base stations 12 are each connected with a higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. The radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter, the radio base stations 11 and 12 will be collectively referred to as “radio base stations 10,” unless specified otherwise.

Each of the user terminals 20 is a terminal that supports various communication schemes such as LTE and LTE-A, and may include not only mobile communication terminals (mobile stations) but stationary communication terminals (fixed stations).

In the radio communication system 1, as radio access schemes, orthogonal frequency division multiple access (OFDMA) is applied to the downlink, and single carrier frequency division multiple access (SC-FDMA) and/or OFDMA is applied to the uplink.

OFDMA is a multi-carrier communication scheme to perform communication by dividing a frequency band into a plurality of narrow frequency bands (subcarriers) and mapping data to each subcarrier. SC-FDMA is a single carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combinations of these, and other radio access schemes may be used.

In the radio communication system 1, a downlink shared channel (PDSCH (Physical Downlink Shared Channel), which is used by each user terminal 20 on a shared basis, a broadcast channel (PBCH (Physical Broadcast Channel)), downlink L1/L2 control channels and so on, are used as downlink channels. User data, higher layer control information, SIBs (System Information Blocks) and so on are communicated on the PDSCH. The MIBs (Master Information Blocks) are communicated on the PBCH.

The downlink L1/L2 control channels include at least one of downlink control channels (a PDCCH (Physical Downlink Control Channel), and/or an EPDCCH (Enhanced Physical Downlink Control Channel), a PCFICH (Physical Control Format Indicator Channel), and a PHICH (Physical Hybrid-ARQ Indicator Channel)). Downlink control information (DCI), including PDSCH and/or PUSCH scheduling information, and so on are communicated on the PDCCH.

Note that the scheduling information may be reported by the DCI. For example, the DCI scheduling DL data reception may be referred to as “DL assignment,” and the DCI scheduling UL data transmission may be referred to as “UL grant.”

The number of OFDM symbols to use for the PDCCH is communicated on the PCFICH. Transmission confirmation information (for example, also referred to as “retransmission control information,” “HARQ-ACK,” “ACK/NACK,” and so on) of HARQ (Hybrid Automatic Repeat reQuest) to a PUSCH is transmitted on the PHICH. The EPDCCH is frequency-division multiplexed with the PDSCH (downlink shared data channel) and used to communicate DCI and so on, like the PDCCH.

In the radio communication system 1, an uplink shared channel (PUSCH (Physical Uplink Shared Channel)), which is used by each user terminal 20 on a shared basis, an uplink control channel (PUCCH (Physical Uplink Control Channel)), a random access channel (PRACH (Physical Random Access Channel)) and so on are used as uplink channels. User data, higher layer control information and so on are communicated on the PUSCH. In addition, radio link quality information (CQI (Channel Quality Indicator)) of the downlink, transmission confirmation information, scheduling request (SR), and so on are transmitted on the PUCCH. By means of the PRACH, random access preambles for establishing connections with cells are communicated.

In the radio communication system 1, a cell-specific reference signal (CRS), a channel state information-reference signal (CSI-RS), a demodulation reference signal (DMRS), a positioning reference signal (PRS), and so on are transmitted as downlink reference signals. In the radio communication system 1, a measurement reference signal (SRS (Sounding Reference Signal)), a demodulation reference signal (DMRS), and so on are transmitted as uplink reference signals. Note that DMRS may be referred to as a “user terminal specific reference signal (UE-specific Reference Signal).” Transmitted reference signals are by no means limited to these.

The radio communication system 1 transmits a synchronization signal (for example, PSS (Primary Synchronization Signal)/SSS (Secondary Synchronization Signal)), a broadcast channel (PBCH (Physical Broadcast Channel), and the like. Note that the synchronization signals and the PBCH may be transmitted in synchronization signal blocks (SSBs).

### <Radio Base Station>

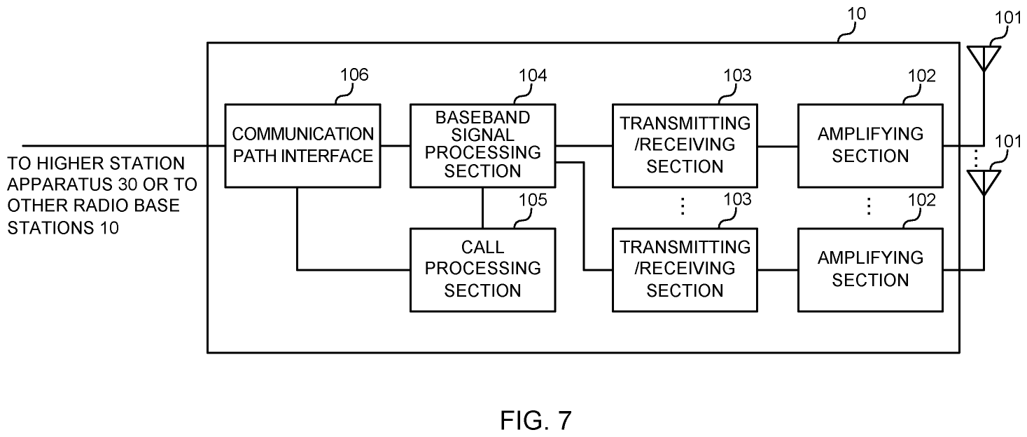

FIG. 7 is a diagram to show an example of an overall structure of the radio base station according to one embodiment. A radio base station 10 includes a plurality of transmitting/receiving antennas 101, amplifying sections 102, transmitting/receiving sections 103, a baseband signal processing section 104, a call processing section 105 and a communication path interface 106. Note that the radio base station 10 may be configured to include one or more transmitting/receiving antennas 101, one or more amplifying sections 102 and one or more transmitting/receiving sections 103.

User data to be transmitted from the radio base station 10 to the user terminal 20 by the downlink is input from the higher station apparatus 30 to the baseband signal processing section 104, via the communication path interface 106.

In the baseband signal processing section 104, the user data is subjected to transmission processes, such as a PDCP (Packet Data Convergence Protocol) layer process, division and coupling of the user data, RLC (Radio Link Control) layer transmission processes such as RLC retransmission control, MAC (Medium Access Control) retransmission control (for example, an HARQ transmission process), scheduling, transport format selection, channel coding, an inverse fast Fourier transform (IFFT) process, and a precoding process, and the result is forwarded to each transmitting/receiving section 103. Furthermore, downlink control signals are also subjected to transmission processes such as channel coding and inverse fast Fourier transform, and the result is forwarded to each transmitting/receiving section 103.

The transmitting/receiving sections 103 convert baseband signals that are pre-coded and output from the baseband signal processing section 104 on a per antenna basis, to have radio frequency bands and transmit the result. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted with transmitters/receivers, transmitting/receiving circuits or transmitting/receiving apparatus that can be described based on general understanding of the technical field to which the present disclosure pertains. Note that each transmitting/receiving section 103 may be structured as a transmitting/receiving section in one entity, or may be constituted with a transmitting section and a receiving section.

Meanwhile, as for uplink signals, radio frequency signals that are received in the transmitting/receiving antennas 101 are amplified in the amplifying sections 102. The transmitting/receiving sections 103 receive the uplink signals amplified in the amplifying sections 102. The transmitting/receiving sections 103 convert the received signals into the baseband signal through frequency conversion and outputs to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (setting up, releasing and so on) for communication channels, manages the state of the radio base station 10, manages the radio resources and so on.

The communication path interface 106 transmits and/or receives signals to and/or from the higher station apparatus 30 via a certain interface. The communication path interface 106 may transmit and/or receive signals (backhaul signaling) with other radio base stations 10 via an inter-base station interface (for example, an optical fiber in compliance with the CPRI (Common Public Radio Interface) and an X2 interface).

The transmitting/receiving sections 103 transmit first downlink control information (DCI) used to schedule uplink shared channels and second downlink control information (DCI) used to schedule downlink shared channels. The transmitting/receiving sections 103 receive the HARQ-ACK for the downlink shared channel on the uplink shared channel.

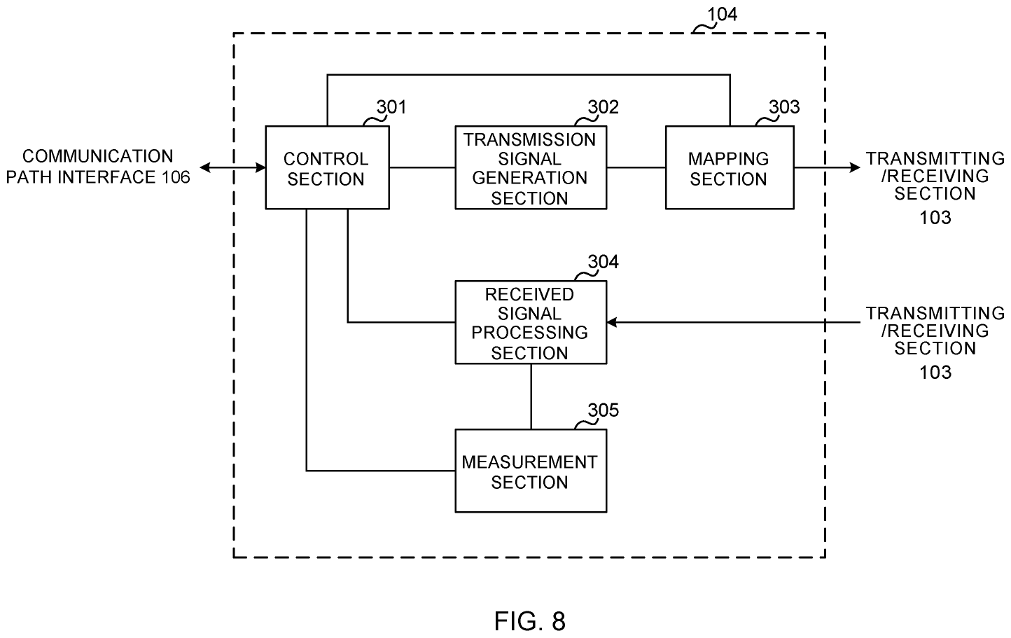

FIG. 8 is a diagram to show an example of a functional structure of the radio base station according to one embodiment. Note that, the present example primarily shows functional blocks that pertain to characteristic parts of one embodiment, and it is assumed that the radio base station 10 includes other functional blocks that are necessary for radio communication as well.

The baseband signal processing section 104 at least includes a control section (scheduler) 301, a transmission signal generation section 302, a mapping section 303, a received signal processing section 304, and a measurement section 305. Note that these structures may be included in the radio base station 10, and some or all of the structures do not need to be included in the baseband signal processing section 104.

The control section (scheduler) 301 controls the whole of the radio base station 10. The control section 301 can be constituted with a controller, a control circuit or control apparatus that can be described based on general understanding of the technical field to which the present disclosure pertains.

The control section 301, for example, controls the generation of signals in the transmission signal generation section 302, the mapping of signals by the mapping section 303, and so on. The control section 301 controls the signal receiving processes in the received signal processing section 304, the measurements of signals in the measurement section 305, and so on.

The control section 301 controls the scheduling (for example, resource assignment) of system information, a downlink data signal (for example, a signal transmitted on the PDSCH), a downlink control signal (for example, a signal transmitted on the PDCCH and/or the EPDCCH. Transmission confirmation information, and so on). Based on the results of determining necessity or not of retransmission control to the uplink data signal, or the like, the control section 301 controls generation of a downlink control signal, a downlink data signal, and so on.

The control section 301 controls the scheduling of a synchronization signal (for example, PSS/SSS), a downlink reference signal (for example, CRS, CSI-RS, DMRS), and so on.

The control section 301 may perform control to form a transmission beam and/or a reception beam by using digital BF by the baseband signal processing section 104 (for example, precoding) and/or analog BF by the transmitting/receiving section 103 (for example, phase rotation).

The control section 301 may perform control to apply depuncture processing and/or rate dematching processing on received uplink data, based on a reception timing when the user terminal 20 receives a transmission indication (for example, the UL grant) on the uplink shared channel (for example, the PUSCH).

The control section 301 controls reception of transmission confirmation information using the uplink shared channel, based on at least one of the number of the transmission confirmation bits on the downlink shared channel and the time from reception of the second DCI until transmission of the uplink shared channel.

The transmission signal generation section 302 generates downlink signals (downlink control signals, downlink data signals, downlink reference signals and so on) based on commands from the control section 301 and outputs the downlink signals to the mapping section 303. The transmission signal generation section 302 can be constituted with a signal generator, a signal generation circuit or signal generation apparatus that can be described based on general understanding of the technical field to which the present disclosure pertains.

For example, the transmission signal generation section 302 generates DL assignment to report assignment information of downlink data and/or UL grant to report assignment information of uplink data, based on commands from the control section 301. The DL assignment and the UL grant are both DCI, and follow the DCI format. For a downlink data signal, encoding processing and modulation processing are performed in accordance with a coding rate, modulation scheme, or the like determined based on channel state information (CSI) from each user terminal 20 and the like.

The mapping section 303 maps the downlink signals generated in the transmission signal generation section 302 to certain radio resources, based on commands from the control section 301, and outputs these to the transmitting/receiving sections 103. The mapping section 303 can be constituted with a mapper, a mapping circuit or mapping apparatus that can be described based on general understanding of the technical field to which the present disclosure pertains.

The received signal processing section 304 performs receiving processes (for example, demapping, demodulation, decoding and so on) of received signals that are input from the transmitting/receiving sections 103. Here, the received signals are, for example, uplink signals that are transmitted from the user terminals 20 (uplink control signals, uplink data signals, uplink reference signals and so on). The received signal processing section 304 can be constituted with a signal processor, a signal processing circuit or signal processing apparatus that can be described based on general understanding of the technical field to which the present disclosure pertains.

The received signal processing section 304 outputs the decoded information acquired through the receiving processes to the control section 301. For example, if the received signal processing section 304 receives the PUCCH including HARQ-ACK, the received signal processing section 304 outputs the HARQ-ACK to the control section 301. The received signal processing section 304 outputs the received signals and/or the signals after the receiving processes to the measurement section 305.

The measurement section 305 conducts measurements with respect to the received signals. The measurement section 305 can be constituted with a measurer, a measurement circuit or measurement apparatus that can be described based on general understanding of the technical field to which the present disclosure pertains.

For example, the measurement section 305 may perform RRM (Radio Resource Management) measurement, CSI (Channel State Information) measurement, and so on, based on the received signal. The measurement section 305 may measure a received power (for example, RSRP (Reference Signal Received Power)), a received quality (for example, RSRQ (Reference Signal Received Quality), an SINR (Signal to Interference plus Noise Ratio), an SNR (Signal to Noise Ratio)), a signal strength (for example, RSSI (Received Signal Strength Indicator)), channel information (for example, CSI), and so on. The measurement results may be output to the control section 301.

### <User Terminal>

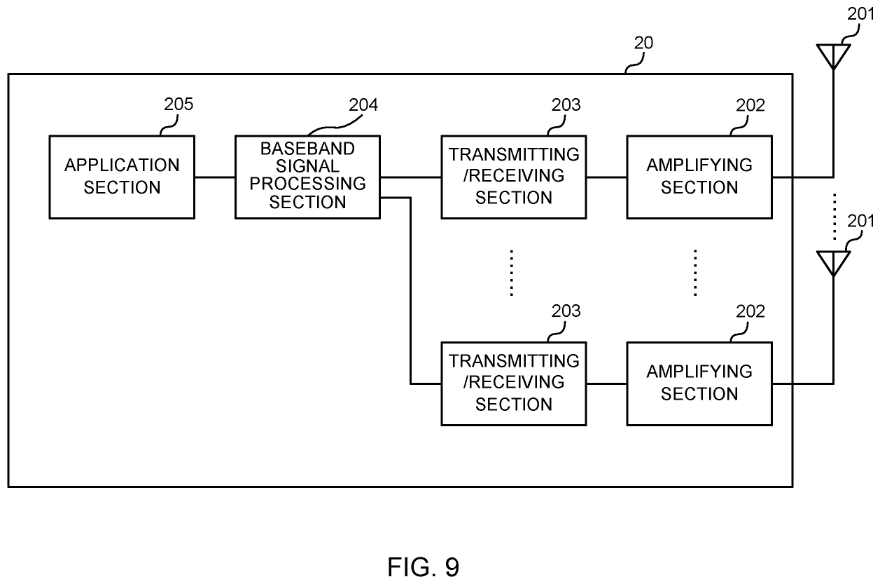

FIG. 9 is a diagram to show an example of an overall structure of a user terminal according to one embodiment. A user terminal 20 includes a plurality of transmitting/receiving antennas 201, amplifying sections 202, transmitting/receiving sections 203, a baseband signal processing section 204 and an application section 205. Note that the user terminal 20 may include one or more transmitting/receiving antennas 201, one or more amplifying sections 202 and one or more transmitting/receiving sections 203.

Radio frequency signals that are received in the transmitting/receiving antennas 201 are amplified in the amplifying sections 202. The transmitting/receiving sections 203 receive the downlink signals amplified in the amplifying sections 202. The transmitting/receiving sections 203 convert the received signals into baseband signals through frequency conversion, and output the baseband signals to the baseband signal processing section 204. The transmitting/receiving sections 203 can be constituted with transmitters/receivers, transmitting/receiving circuits or transmitting/receiving apparatus that can be described based on general understanding of the technical field to which the present disclosure pertains. Note that each transmitting/receiving section 203 may be structured as a transmitting/receiving section in one entity, or may be constituted with a transmitting section and a receiving section.

The baseband signal processing section 204 performs, on each input baseband signal, an FFT process, error correction decoding, a retransmission control receiving process, and so on. The downlink user data is forwarded to the application section 205. The application section 205 performs processes related to higher layers above the physical layer and the MAC layer, and so on. In the downlink data, broadcast information may be also forwarded to the application section 205.

Meanwhile, the uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving section 203.

The transmitting/receiving sections 203 convert the baseband signals output from the baseband signal processing section 204 to have radio frequency band and transmit the result. The radio frequency signals having been subjected to frequency conversion in the transmitting/receiving sections 203 are amplified in the amplifying sections 202, and transmitted from the transmitting/receiving antennas 201.

The transmitting/receiving sections 203 receive second downlink control information (DCI) used to schedule downlink shared channels, after receiving first downlink control information (DCI) used to schedule uplink shared channels. The transmitting/receiving sections 203 may receive transmission confirmation information by using the uplink shared channel, based on at least one of the number of the transmission confirmation bits on the downlink shared channel and the time from reception of the second DCI until transmission of the uplink shared channel.

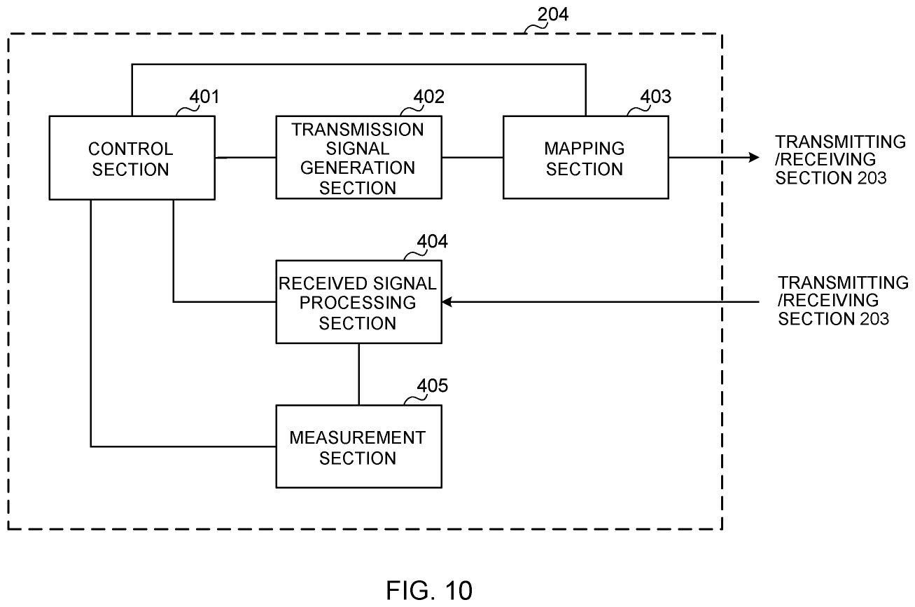

FIG. 10 is a diagram to show an example of a functional structure of a user terminal according to one embodiment. Note that, the present example primarily shows functional blocks that pertain to characteristic parts of one embodiment, and it is assumed that the user terminal 20 includes other functional blocks that are necessary for radio communication as well.

The baseband signal processing section 204 provided in the user terminal 20 at least includes a control section 401, a transmission signal generation section 402, a mapping section 403, a received signal processing section 404 and a measurement section 405. Note that these structures may be included in the user terminal 20, and some or all of the structures do not need to be included in the baseband signal processing section 204.

The control section 401 controls the whole of the user terminal 20. The control section 401 can be constituted with a controller, a control circuit or control apparatus that can be described based on general understanding of the technical field to which the present disclosure pertains.

The control section 401, for example, controls the generation of signals in the transmission signal generation section 402, the mapping of signals by the mapping section 403, and so on. The control section 401 controls the signal receiving processes in the received signal processing section 404, the measurements of signals in the measurement section 405, and so on.

The control section 401 acquires a downlink control signal and a downlink data signal transmitted from the radio base station 10, from the received signal processing section 404. The control section 401 controls generation of an uplink control signal and/or an uplink data signal, based on the results of determining necessity or not of retransmission control to a downlink control signal and/or a downlink data signal.

The control section 401 may perform control to form a transmission beam and/or a reception beam by using digital BF by the baseband signal processing section 204 (for example, precoding) and/or analog BF by the transmitting/receiving section 203 (for example, phase rotation).

The control section 401 controls transmission of transmission confirmation information using the uplink shared channel, based on at least one of the number of the transmission confirmation bits on the downlink shared channel and the time from reception of the second DCI used to schedule the downlink shared channel until transmission of the uplink shared channel.

For example, in a case where the number of the transmission confirmation bits is equal to or smaller than a certain threshold, the control section 401 may transmit the transmission confirmation bits, with uplink data transmitted on the uplink shared channel punctured. In a case where the number of the transmission confirmation bits is larger than the certain threshold, the control section 401 may suspend the transmission of the transmission confirmation bits exceeding the certain threshold.

Alternatively, in a case where the time from the reception of the second DCI until the transmission of the uplink shared channel is equal to or longer than the certain threshold or is longer than the certain threshold, the control section 401 may transmit the transmission confirmation bits, with uplink data transmitted on the uplink shared channel rate-matched.

Alternatively, in a case where the time from the reception of the second DCI until the transmission of the uplink shared channel is shorter than the certain threshold or is equal to or shorter than the certain threshold, the control section 401 may suspend the transmission of the transmission confirmation bits. Alternatively, in a case where the time from the reception of the second DCI until the transmission of the uplink shared channel is shorter than the certain threshold or is equal to or shorter than the certain threshold, the control section 401 may transmit the transmission confirmation bits, with uplink data transmitted on the uplink shared channel punctured.

The transmission signal generation section 402 generates uplink signals (uplink control signals, uplink data signals, uplink reference signals and so on) based on commands from the control section 401, and outputs the uplink signals to the mapping section 403. The transmission signal generation section 402 can be constituted with a signal generator, a signal generation circuit or signal generation apparatus that can be described based on general understanding of the technical field to which the present disclosure pertains.

For example, the transmission signal generation section 402 generates an uplink control signal about transmission confirmation information, the channel state information (CSI), and so on, based on commands from the control section 401. The transmission signal generation section 402 generates uplink data signals, based on commands from the control section 401. For example, when a UL grant is included in a downlink control signal that is reported from the radio base station 10, the control section 401 commands the transmission signal generation section 402 to generate the uplink data signal.

The mapping section 403 maps the uplink signals generated in the transmission signal generation section 402 to radio resources, based on commands from the control section 401, and outputs the result to the transmitting/receiving sections 203. The mapping section 403 can be constituted with a mapper, a mapping circuit or mapping apparatus that can be described based on general understanding of the technical field to which the present disclosure pertains.

The received signal processing section 404 performs receiving processes (for example, demapping, demodulation, decoding and so on) of received signals that are input from the transmitting/receiving sections 203. Here, the received signals are, for example, downlink signals transmitted from the radio base station 10 (downlink control signals, downlink data signals, downlink reference signals and so on). The received signal processing section 404 can be constituted with a signal processor, a signal processing circuit or signal processing apparatus that can be described based on general understanding of the technical field to which the present disclosure pertains. The received signal processing section 404 can constitute the receiving section according to the present disclosure.

The received signal processing section 404 outputs the decoded information acquired through the receiving processes to the control section 401. The received signal processing section 404 outputs, for example, broadcast information, system information, RRC signaling, DCI and so on, to the control section 401. The received signal processing section 404 outputs the received signals and/or the signals after the receiving processes to the measurement section 405.

The measurement section 405 conducts measurements with respect to the received signals. The measurement section 405 can be constituted with a measurer, a measurement circuit or measurement apparatus that can be described based on general understanding of the technical field to which the present disclosure pertains.

For example, the measurement section 405 may perform RRM measurement, CSI measurement, and so on, based on the received signal. The measurement section 405 may measure a received power (for example, RSRP), a received quality (for example, RSRQ, SINR, SNR), a signal strength (for example, RSSI), channel information (for example, CSI), and so on. The measurement results may be output to the control section 401.

### <Hardware Structure>

Note that the block diagrams that have been used to describe the above embodiments show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire and/or wireless, for example) and using these plurality of pieces of apparatus.

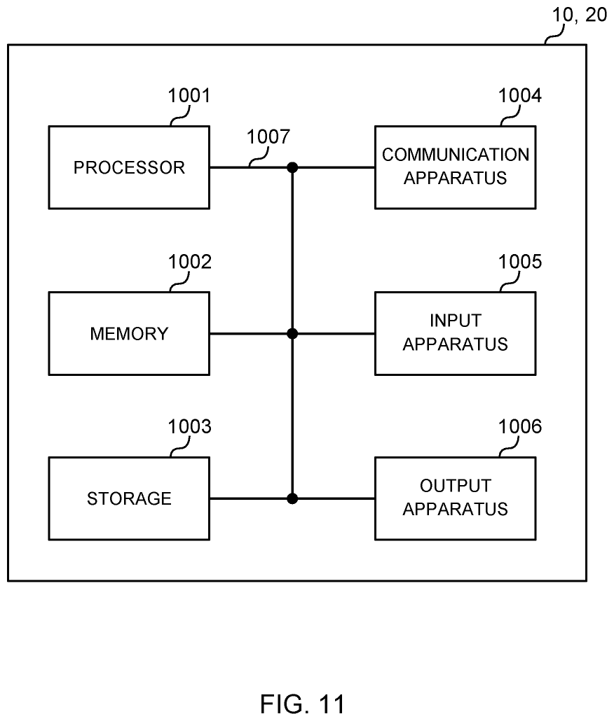

For example, a radio base station, a user terminal, and so on according to one embodiment may function as a computer that executes the processing in the aspects of one embodiment. FIG. 11 is a diagram to show an example of a hardware structure of the radio base station and the user terminal according to one embodiment. Physically, the above-described radio base station 10 and user terminals 20 may each be formed as computer apparatus that includes a processor 1001, a memory 1002, a storage 1003, a communication apparatus 1004, an input apparatus 1005, an output apparatus 1006, a bus 1007, and so on.

Note that, in the following description, the word “apparatus” may be interpreted as “circuit,” “device,” “unit,” and so on. The hardware structure of the radio base station 10 and the user terminals 20 may be designed to include one or a plurality of apparatuses shown in the drawings, or may be designed not to include part of pieces of apparatus.

For example, although only one processor 1001 is shown, a plurality of processors may be provided. Furthermore, processes may be implemented with one processor or may be implemented at the same time, in sequence, or in different manners with one or more processors. Note that the processor 1001 may be implemented with one or more chips.

Each function of the radio base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and read and/or write data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data, and so on from the storage 1003 and/or the communication apparatus 1004, into the memory 1002, and executes various processes according to these. As for the programs, programs to allow computers to execute at least part of the operations of the above-described embodiments are used. For example, the control section 401 of each user terminal 20 may be implemented by control programs that are stored in the memory 1002 and that operate on the processor 1001, and other functional blocks may be implemented likewise.

The memory 1002 is a computer-readable recording medium, and may be constituted with, for example, at least one of a ROM (Read Only Memory), an EPROM (Erasable Programmable ROM), an EEPROM (Electrically EPROM), a RAM (Random Access Memory), and other appropriate storage media. The memory 1002 may be referred to as a “register,” a “cache,” a “main memory (primary storage apparatus)” and so on. The memory 1002 can store executable programs (program codes), software modules, and/or the like for implementing a radio communication method according to one embodiment.

The storage 1003 is a computer-readable recording medium, and may be constituted with, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via wired and/or wireless networks, and may be referred to as, for example, a “network device,” a “network controller,” a “network card,” a “communication module” and so on. The communication apparatus 1004 may be configured to include a high frequency switch, a duplexer, a filter, a frequency synthesizer, and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106, and so on may be implemented by the communication apparatus 1004.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, an LED (Light Emitting Diode) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the radio base station 10 and the user terminals 20 may be structured to include hardware such as a microprocessor, a digital signal processor (DSP), an ASIC (Application Specific Integrated Circuit), a PLD (Programmable Logic Device), an FPGA (Field Programmable Gate Array), and so on, and part or all of the functional blocks may be implemented by the hardware. For example, the processor 1001 may be implemented with at least one of these pieces of hardware.

### (Variations)

Note that the terminology used in this specification and/or the terminology that is needed to understand this specification may be replaced by other terms that convey the same or similar meanings. For example, “channels” and/or “symbols” may be replaced by “signals” (“signaling”). Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

Furthermore, a radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may have a fixed time length (for example, 1 ms) independent of numerology.

Furthermore, a slot may be constituted of one or a plurality of symbols in the time domain (OFDM (Orthogonal Frequency Division Multiplexing) symbols, SC-FDMA (Single Carrier Frequency Division Multiple Access) symbols, and so on). Furthermore, a slot may be a time unit based on numerology. A slot may include a plurality of mini-slots. Each mini-slot may be constituted of one or a plurality of symbols in the time domain. A mini-slot may be referred to as a “sub-slot.”

A radio frame, a subframe, a slot, a mini-slot, and a symbol all express time units in signal communication. A radio frame, a subframe, a slot, a mini-slot, and a symbol may each be called by other applicable terms. For example, one subframe may be referred to as a “transmission time interval (TTI)”, a plurality of consecutive subframes may be referred to as a “TTI” or one slot or one mini-slot may be referred to as a “TTI.” That is, a subframe and/or a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a radio base station schedules the allocation of radio resources (such as a frequency bandwidth and transmission power that are available for each user terminal) for the user terminal in TTI units. Note that the definition of TTIs is not limited to this.

TTIs may be transmission time units for channel-encoded data packets (transport blocks), code blocks, and/or codewords, or may be the unit of processing in scheduling, link adaptation, and so on. Note that, when TTIs are given, the time interval (for example, the number of symbols) to which transport blocks, code blocks and/or codewords are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in LTE Rel. 8 to Rel. 12), a “long TTI,” a “normal subframe,” a “long subframe” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. Also, an RB may include one or a plurality of symbols in the time domain, and may be one slot, one mini-slot, one subframe, or one TTI in length. One TTI and one subframe each may be constituted of one or a plurality of resource blocks. Note that one or a plurality of RBs may be referred to as a “physical resource block (PRB (Physical RB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in this specification may be represented in absolute values or in relative values with respect to certain values, or may be represented in another corresponding information. For example, radio resources may be specified by certain indices.

The names used for parameters and so on in this specification are in no respect limiting. For example, since various channels (PUCCH (Physical Uplink Control Channel), PDCCH (Physical Downlink Control Channel), and so on) and information elements can be identified by any suitable names, the various names assigned to these individual channels and information elements are in no respect limiting.

The information, signals, and/or others described in this specification may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers and/or from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (master information block (MIB), system information blocks (SIBs), and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as an “RRC message,” and can be, for example, an RRC connection setup (RRCConnectionSetup) message, an RRC connection reconfiguration (RRCConnectionReconfiguration) message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using wired technologies (coaxial cables, optical fiber cables, twisted-pair cables, digital subscriber lines (DSL), and so on) and/or wireless technologies (infrared radiation, microwaves, and so on), these wired technologies and/or wireless technologies are also included in the definition of communication media.

The terms “system” and “network” as used in this specification are used interchangeably.

In the present specification, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or a plurality of (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part of or the entire coverage area of a base station and/or a base station subsystem that provides communication services within this coverage.

In the present specification, the terms “mobile station (MS),” “user terminal,” “user equipment (UE),” and “terminal” may be used interchangeably.

A mobile station may be referred to as, by a person skilled in the art, a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

Furthermore, the radio base stations in this specification may be interpreted as user terminals. For example, each aspect/embodiment of the present disclosure may be applied to a configuration in which communication between a radio base station and a user terminal is replaced with communication among a plurality of user terminals (D2D (Device-to-Device)). In this case, the user terminals 20 may have the functions of the radio base stations 10 described above. In addition, wording such as “uplink” and “downlink” may be interpreted as “side.” For example, an uplink channel may be interpreted as a side channel.

Likewise, the user terminals in this specification may be interpreted as radio base stations. In this case, the radio base stations 10 may have the functions of the user terminals 20 described above.

Actions which have been described in this specification to be performed by a base station may, in some cases, be performed by upper nodes. In a network including one or a plurality of network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The aspects/embodiments illustrated in this specification may be used individually or in combinations, which may be switched depending on the mode of implementation. The order of processes, sequences, flowcharts, and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments described herein may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR(New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods and/or next-generation systems that are enhanced based on these.

The phrase “based on” (or “on the basis of”) as used in this specification does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second” and so on as used herein does not generally limit the quantity or order of these elements. These designations may be used herein only for convenience, as a method for distinguishing between two or more elements. Thus, reference to the first and second elements does not imply that only two elements may be employed, or that the first element must precede the second element in some way.

The term “judging (determining)” as used herein may encompass a wide variety of actions. For example, “judging (determining)” may be interpreted to mean making “judgments (determinations)” about calculating, computing, processing, deriving, investigating, looking up (for example, searching a table, a database, or some other data structures), ascertaining, and so on. Furthermore, “judging (determining)” may be interpreted to mean making “judgments (determinations)” about receiving (for example, receiving information), transmitting (for example, transmitting information), input, output, accessing (for example, accessing data in a memory), and so on. In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

The terms “connected” and “coupled,” or any variation of these terms as used herein mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In this specification, when two elements are connected, the two elements may be considered “connected” or “coupled” to each other by using one or more electrical wires, cables and/or printed electrical connections, and, as some non-limiting and non-inclusive examples, by using electromagnetic energy having wavelengths in radio frequency regions, microwave regions, (both visible and invisible) optical regions, or the like.

In this specification, the phrase “A and B are different” may mean that “A and B are different from each other.” The terms “separate,” “be coupled” and so on may be interpreted similarly.

When terms such as “including,” “comprising,” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the invention has been described in detail above, it should be obvious to a person skilled in the art that the invention is by no means limited to the embodiments described in this specification. The present invention can be implemented with various corrections and in various modifications, without departing from the gist and scope of the present invention defined by the recitations of claims. Consequently, the description in this specification is provided only for the purpose of explaining examples, and should by no means be construed to limit the invention in any way.

1. A user terminal comprising:
a receiving section that receives, after receiving first downlink control information (DCI) used to schedule an uplink shared channel, second downlink control information (DCI) used to schedule a downlink shared channel; and
a control section that controls, based on at least one of a number of transmission confirmation bits on the downlink shared channel and a time from reception of the second DCI until transmission of the uplink shared channel, transmission of transmission confirmation information using the uplink shared channel.

2. The user terminal according to claim 1, wherein
in a case where the number of the transmission confirmation bits is equal to or smaller than a certain threshold, the control section transmits the transmission confirmation bits, with uplink data transmitted on the uplink shared channel punctured.

3. The user terminal according to claim 1, wherein
in a case where the number of the transmission confirmation bits is larger than the certain threshold, the control section suspends the transmission of the transmission confirmation bits exceeding the certain threshold.

4. The user terminal according to claim 1, wherein
in a case where the time from the reception of the second DCI until the transmission of the uplink shared channel is equal to or longer than a certain threshold or is longer than the certain threshold, the control section transmits the transmission confirmation bits, with the uplink data transmitted on uplink shared channel rate-matched.

5. The user terminal according to claim 1, wherein
in a case where the time from the reception of the second DCI until the transmission of the uplink shared channel is shorter than the certain threshold or is equal to or shorter than the certain threshold, the control section suspends the transmission of the transmission confirmation bits.

6. The user terminal according to claim 1, wherein
in a case where the time from the reception of the second DCI until the transmission of the uplink shared channel is shorter than the certain threshold or is equal to or shorter than the certain threshold, the control section transmits the transmission confirmation bits, with uplink data transmitted on the uplink shared channel punctured.

7. The user terminal according to claim 2, wherein
in a case where the number of the transmission confirmation bits is larger than the certain threshold, the control section suspends the transmission of the transmission confirmation bits exceeding the certain threshold.

8. The user terminal according to claim 4, wherein
in a case where the time from the reception of the second DCI until the transmission of the uplink shared channel is shorter than the certain threshold or is equal to or shorter than the certain threshold, the control section suspends the transmission of the transmission confirmation bits.

9. The user terminal according to claim 5, wherein
in a case where the time from the reception of the second DCI until the transmission of the uplink shared channel is shorter than the certain threshold or is equal to or shorter than the certain threshold, the control section transmits the transmission confirmation bits, with uplink data transmitted on the uplink shared channel punctured.

10. The user terminal according to claim 6, wherein
in a case where the time from the reception of the second DCI until the transmission of the uplink shared channel is shorter than the certain threshold or is equal to or shorter than the certain threshold, the control section transmits the transmission confirmation bits, with uplink data transmitted on the uplink shared channel punctured.
